(19) United States
(12) Patent Application Publication
(10) Pub. No.: US 2014/0096014 A1
(43) Pub. Date: Apr. 3, 2014

(54) METHOD FOR ENABLING DYNAMIC CLIENT USER INTERFACES ON MULTIPLE PLATFORMS FROM A COMMON SERVER APPLICATION VIA METADATA

(71) Applicant: ORACLE INTERNATIONAL CORPORATION, Redwood Shores, CA (US)

(72) Inventors: Mark A. Johnson, Denver, CO (US); Darryl Martin Shakespeare, Denver, CO (US)

(73) Assignee: Oracle International Corporation, Redwood Shores, CA (US)

(21) Appl. No.: 13/829,274

(22) Filed: Mar. 14, 2013

Related U.S. Application Data
(60) Provisional application No. 61/707,927, filed on Sep. 29, 2012.

(51) Int. Cl. H04L 12/24

(52) U.S. Cl. CPC H04L 41/22
USPC 715/733

(57) ABSTRACT

A system and method for facilitating modifying a client user interface display screen via a server and accompanying server-side software. An example method includes employing a client device to receive metadata from a server, wherein the metadata includes a description of one or more User Interface (UI) elements to be displayed on the client device; and using an application running on the client device to employ the metadata to display one or more platform-specific user interface features based on a platform on which the application is running. In general, example embodiments described herein include software and accompanying methods for enabling generation of dynamic native client user interfaces on multiple different client platforms based on common metadata definitions (or code for generating the metadata definitions) delivered to the different client platforms.

### CROSS REFERENCES TO RELATED APPLICATIONS

This application claims priority from U.S. Provisional Patent Application Ser. No. 61/707,927, entitled METHOD FOR ENABLING DYNAMIC CLIENT USER INTERFACES ON MULTIPLE PLATFORMS FROM A COMMON SERVER APPLICATION VIA METADATA, filed on Sep. 25, 2012, which is hereby incorporated by reference as if set forth in full in this application for all purposes.

### BACKGROUND

The present application relates to software and more specifically to systems and methods for facilitating displaying client-side graphical user interface elements based on information retrieved from a server.

Methods for rendering User Interface (UI) features on a client device based on server-side content are employed in various applications, including display of interactive Web pages, implementation of mobile enterprise applications employing Service Oriented Architectures (SOAs), and so on. Such applications often demand readily configurable content and accompanying UI elements for interacting with potentially complex software feature sets.

Conventionally, a client device, such as a mobile phone, tablet, or desktop computer, may employ a browser or other networked application to retrieve content, such as webpage content, from a server. The content may include instructions (e.g., HTML) for displaying UI elements, such as buttons, tables, menus, forms, and so on, with in a browser display area. However, UI elements based on conventional HTML and JavaScript content retrieved from a server typically appear and function similarly, despite which platform the applications are running on.

Accordingly, client-side applications that use platform-specific features and accompanying UI elements, are often custom designed for each platform (e.g., iPhone, Android, Windows Mobile, Symbian, BlackBerry, etc.). However, this can be labor intensive, requiring significant engineering investment to target multiple platforms.

Increasing popularity of mobile devices has paralleled increasing demand for rich software features that leverage interactions between native client applications and server-side applications, such as web services. This has coincided with significant platform fragmentation, where different platforms use different UI conventions. This has further propelled developers to take costly steps to build custom applications for each platform to accommodate the different UI conventions.

Furthermore, in cases where a client-side application communicates with server-side components, any updates to the server-side components may necessitate corresponding client-side adjustments. However, using conventional methods to deliver updates to potentially thousands or millions of client devices running client-side instances of a given application can be problematic.

### SUMMARY

An example method facilitates modifying a client user interface display screen via a server and accompanying server-side software, such as web services. The example method includes employing a client device to receive metadata from a server, wherein the metadata includes a description of one or more User Interface (UI) elements to be displayed on the client device, and then using an application running on the client device to employ the metadata to display one or more platform-specific user interface features based on a platform on which the application is running.

In a more specific embodiment, the example method facilitates displaying a metadata-based User Interface (UI) element by utilizing client-side software to interpret the metadata to construct a metadata-based UI element. The metadata includes a JavaScript Object Notation (JSON) definition of one or more UI elements. The JSON definition may include a description of a behavior of a UI element; a description of one or more actions that can be performed in response to user selection of the UI element; a characterization of a location of the UI element, and so on.

Hence, example embodiments described herein include software and accompanying methods for enabling generation of dynamic native client UIs and accompanying UI elements on multiple different client platforms based on common metadata definitions delivered to the different client platforms. A client-side application running on a particular type of platform is adapted to selectively request metadata from a server, wherein the metadata describes or defines certain dynamic user interface components or elements to be displayed on a client device via a client-side application. Accordingly, certain embodiments described herein may employ both client-side and server-side functionality to facilitate platform-independent generation of dynamic user interface features or components displayed on the client device.

By designing a server-based application to deliver an abstract definition of the client user interface and/or accompanying elements or components as metadata, client applications can be developed for each platform that consume that metadata and construct the user interface at runtime in a manner that follows the user interface conventions of the platform or device. By delegating business logic, data processing, and abstract user interface definitions to the server component of the system, the cost of developing a client application specific to each platform can be reduced.

Furthermore, using server-delivered metadata descriptions of UI elements, as discussed herein, may reduce or obviate the need for developers to develop different client apps for different platforms and may further facilitate modifying and updating client-side applications by merely making adjustments to server-side metadata descriptions.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram of an example system for facilitating platform-independent generation of dynamic native client user interface components from a metadata definition delivered via a server.

FIG. 2 is diagram illustrating an example process flow adapted for use with the system of FIG. 1.

FIG. 3 is a diagram illustrating summaries of example object oriented computing objects (e.g., classes) representing JSON metadata definitions for an example data item user interface element and an example menu item UI element.

FIG. 4 is a diagram of an example client device and accompanying user interface display screen illustrating examples of dynamically generated native elements based on metadata in combination with a webpage and conventional HTML-based user interface elements.

FIG. 5 is a flow diagram of an example method adapted for use with the embodiments of FIGS. 1-4.

### DETAILED DESCRIPTION OF EMBODIMENTS

For the purposes of the present discussion, metadata may be any data or information describing data or otherwise describing data and/or functionality, such as User Interface (UI) element, an application, a process, or set of processes or services. Metadata may also include computer code, e.g., for triggering one or more actions associated with a UI element.

Software functionality, also simply called functionality herein, may be any function, capability, or feature, that is provided via computer code, i.e., software. Generally, software functionality may be accessible via use of a user interface and accompanying user interface controls and features. Software functionality may include actions, such as retrieving data pertaining to a computing object (e.g., business object); performing an enterprise-related task, such as promoting, hiring, and firing enterprise personnel, placing orders, calculating analytics, launching certain dialog boxes, performing searches, and so on.

A software action, also simply called action herein, may be any process or collection of processes or operations implemented via software. Additional examples of processes include updating or editing data in a database, viewing sales orders, accessing an address book, managing bookmarks or favorite links, placing a product order, displaying data visualizations or analytics, triggering a sequence of processes for facilitating automating hiring, firing, or promoting a worker, launching an Enterprise Resource Planning (ERP) software application, displaying a dialog box for enabling time entries, calling a Web service to perform another action, and so on.

A UI element may be any graphical depiction of a user interface section, portion, or feature, such as a user interface control. A user interface control may be any displayed element or component of a user interface display screen, which is adapted to enable a user to provide input, view data, and/or otherwise interact with a user interface. Additional examples of user interface controls include buttons, drop down menus, menu items, tap-and-hold functionality, and so on. Similarly, a user interface control signal may be any signal that is provided as input for software, wherein the input affects a user interface display screen and/or accompanying software application associated with the software.

A metadata based UI element may be any UI element that is constructed or displayed by a client device with reference to metadata describing UI element. A dynamic UI element may be any UI element that may be modified or otherwise generated based on instructions or other information retrieved from a server.

A native element of a user interface display screen may be UI element, such as a UI control, whose appearance or functionality is based on one or more characteristics of the platform upon which the element is displayed. A characteristic of a platform may be any software or hardware feature, set of features, or characteristics of a client device.

Conventionally, native elements of a client-side UI display screen are rendered via client-side software independent of information retrieved from a server. However, embodiments discussed herein enable client-side generation and rendering of UI elements by referencing metadata retrieved from a server, as discussed more fully below.

For clarity, certain well-known components, such as hard drives, processors, operating systems, power supplies, routers, Internet Service Providers (ISPs), and so on, have been omitted from the figures. However, those skilled in the art with access to the present teachings will know which components to implement and how to implement them to meet the needs of a given implementation.

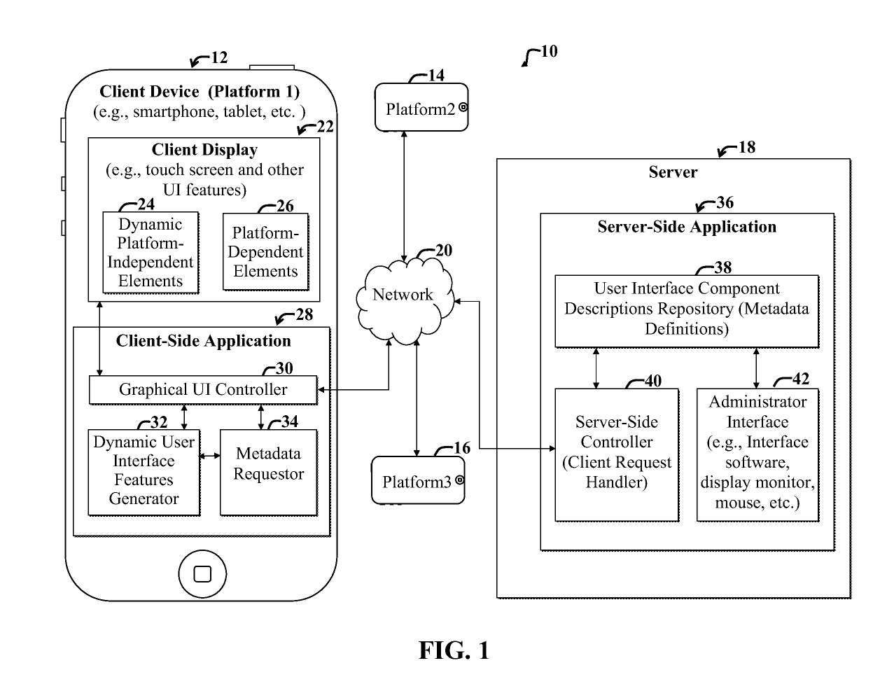

FIG. 1 is a diagram of a system 10 for facilitating platform-independent generation of dynamic native client user interface components 24 from one or more metadata definitions 38 delivered to one or more client devices 12-16 via a server 18.

For the purposes of the present discussion, a server may be any computing resource, such as a computer and/or software that is adapted to provide content, e.g., data and/or functionality, to another computing resource or entity that requests it, i.e., the client. A client may be any computer or system that is adapted to receive content from another computer or system, called a server. A client device may be any computer, e.g., smartphone, tablet, desktop computer, and so on, that is adapted to communicate with a server and receive content therefrom.

Various client devices 12-16 communicate with the server 18 via a network 20, such as the Internet. In the present example embodiment, each of the client devices 12-16 runs on a different platform, e.g., iOS, Android, BlackBerry, Win32, Windows 8, etc. Note that while the client devices 12-16 are shown as mobile devices, embodiments are not limited thereto. One or more clients may be desktop computers or other computing devices.

Example components 22-34 of the client device 12 are adapted to facilitate dynamic generation of content, e.g., UI elements 24, based on metadata descriptions of associated user interface elements or components retrieved from a metadata repository 38 of a server side application 36 running on the server 18. The server-side application 36 may be implemented via one or more web services and/or Application Programming Interfaces (APIs) and/or may call one or more additional web services or other server-side applications.

For the purposes of the present discussion, user interface content may be any information characterizing a user interface display screen, such as an appearance and/or functionality. User interface content may include HyperText Markup Language (HTML) characterizations of webpage content to be displayed in a web client window (e.g., a browser window) and may further include other information, such as metadata, characterizing UI elements that are adapted to be read by client-side software and rendered in accordance with and consistent with the client-side platform. The term platform may refer to the operating system and accompanying device features, including resident hardware and software functionality.

Note that while the server 18 is shown in a single block, that the server 18 may represent a server cluster that hosts plural web services that may provide information for metadata-based UI element generation via the client devices 12-16.

A server-side controller 40 includes instructions for responding to metadata requests from a client-side application 28. The example client-side application 28 includes a dynamic user interface features/elements generator 32 and a metadata requestor module 34 in communication with a Graphical User Interface (GUI) controller 30.

The dynamic user interface features/elements generator 32 includes computer code for reading metadata retrieved from the server 18 via the metadata requestor 34. For example, the interface features/elements generator 32 may include, depending upon the needs of a given implementation, JavaScript interpreter to execute JSON text dynamically as client-side JavaScript to produce native JavaScript computing objects. The client-side application 28 may include built-in native JSON encoding/decoding software, and/or may include JavaScript functions, such as the JavaScript eval( ) and JSON.parse( ) functions used to read and interpret, i.e., execute, JSON data to facilitate constructing metadata-based UI elements, as discussed more fully below.

In an example operative scenario, computer code executed by the metadata requestor 34 initiates a request for metadata data user interface component definitions from the server 18 via the GUI controller 30 and network 20 in response to a signal from the dynamic user interface features/elements generator 32 and/or from the GUI controller 30. The dynamic user interface features/elements generator 32 in turn may receive commands and signals from the GUI controller 30 in accordance with a user interface specification implemented via the client-side application 28.

The client-side application 28 is adapted to generate both platform-dependent user interface elements 26 and dynamic elements 24. The dynamic elements 24 are constructed in a manner consistent with the platform on which the client-side application 28 runs. Nevertheless, since the dynamic elements 24 are generated based on platform-independent instructions (e.g., delivered via JavaScript Object Notation (JSON) messages), the dynamic elements 24 are considered to represent implementations of platform-independent element descriptions. Accordingly, for the purposes of the present discussion, the dynamic elements 24 are considered as platform-independent elements. User interface features representing the metadata-described user interface elements may be displayed on any of the mobile devices 12-16, despite what platform or operating system the mobile devices 12-16 are running on.

An optional server-side administrator interface 42 enables an administrator to make adjustments, e.g., adjustments to settings and metadata descriptions, to the server-side application 36. This enables administrators to effectively and efficiently propagate certain changes or updates to the client devices 12-16 without the need for re-installation of the client-side application(s) 28.

Note that metadata definitions characterizing client-side UI elements can be generated by server-side methods directly in source code in addition to being retrieved from a central repository, without departing from the scope of the present teachings. In such cases, the administration interface 42 may not necessarily be applicable. Instead, a developer may make server-side code changes to modify or update client-side UI elements. In such cases, the benefit of not requiring client-side application reinstallation to update client-side UIs still applies.

The dynamic user interface features generator 32 includes computer code for reading metadata that has been retrieved by the metadata requestor 34 from the server-side application 36. The retrieved metadata descriptions include sufficient information to enable the dynamic user interface features generator 32 to dynamically construct UI components 24 in a manner that is consistent with the platform (including platform operating system, e.g., iOS, Android, etc., and other platform-specific software and hardware features, e.g., display type and resolution) of the client 12.

Hence, the system 10 implements a method for enabling dynamic native client user interfaces on multiple platforms from a common metadata definition (and/or definition-generating computer code) delivered via a server 18. The server-side application 36 provides the metadata, and in combination with the client-side application 28, together the applications 28, 36 act as a platform-independent hybrid server-side and client-side application.

In a traditional web-based application, a server component of a system delivers a HyperText Markup Language (HTML)-based version of the application's user interface to the client for display in a web browser. However, as set forth above, embodiments herein instead use the server component 18 of the system 10 to deliver an abstract definition of the user interface as JSON metadata. The abstract user interface definition describes the abstract type of each UI element or component, the behavior of the element, recommended layout information (e.g., a position of a UI element), and actions that can be performed in response to user selection of the UI element.

The client application 28 of each platform provides a platform-specific implementation of the non-dynamic elements 26 of UI. When the application launches, the client application 28 requests the dynamic aspects 24 of the UI from the server 18. Once the client receives the UI metadata, the client application 28 generates a UI element for each UI element definition received from the server 18.

The dynamic metadata-based UI elements 24 are created as elements (also called components) native to the platform (HTML elements for a web client, native iOS controls for iOS devices, Win32 or .NET controls for a Windows client, etc.). The client application 28 then lays out the application using a user interface and navigation paradigms relevant to the platform. The process is repeated as dynamic UI information is needed by the client-side application 28.

By designing a server-based (also called server-side herein) application to deliver an abstract definition of the client UI as metadata, client applications can be developed for each platform that consume that metadata and can construct the UI at runtime in a manner that follows the user interface conventions of the platform or device. By delegating business logic, data processing, and abstract user interface definition to the server component of the system, the cost of developing a client application specific to each platform can be reduced.

In addition, by having the server component provide all business logic and the single abstract definition of the user interface that is used by each client application, enhancements and modifications to the system 10 can be implemented on the server 18 and delivered to each client 12-16 as metadata rather than requiring modifications to each client application.

An example method suitable for use with the embodiment of FIG. 1 includes employing a client device to receive metadata from a server, wherein the metadata includes a description of one or more components to be displayed on the client device; using an application running on the client device to display one or more platform-specific user interface navigation features of the application running on the mobile device based on a platform on which the application is running.

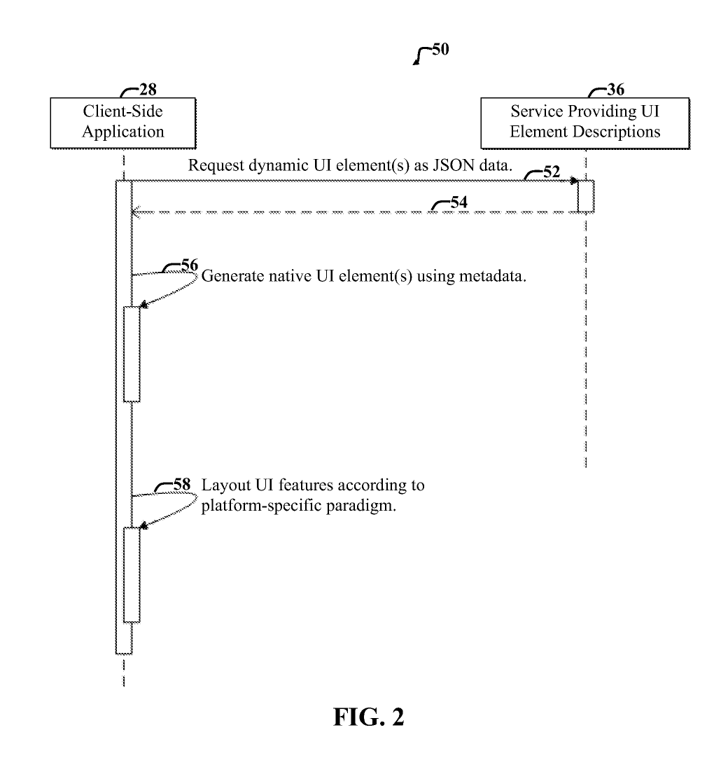

FIG. 2 is diagram illustrating an example process flow 50 adapted for use with the system 10 of FIG. 1. The process flow 50 illustrates an example interaction between the client-side application 28, and a server-side application 36, such as a Web service, that provides UI element JSON metadata descriptions to the client-side application 28.

A first step 52 involves transferring a request message from the client-side application 28 to the server-side application 36. The request message includes a request for JSON metadata description(s) of one or more dynamic UI element(s) to be displayed via a client device hosting the client-side application 28. The server-side application 36 responds with a message 54 containing the requested JSON metadata.

Subsequently, in a UI-element generating step 56, the client-side application 28 generates one or more metadata-based UI elements based on the received JSON metadata. The generated UI elements may be generated with reference to both the JSON metadata descriptions and with reference to any unique client-side platform capabilities or lack thereof. The UI elements are generated in a manner that is compatible with the client-side platform.

Next, in a layout step, the client-side application 28 lays out and positions the one or more generated UI elements and accompanying features in accordance with a platform-specific paradigm that is consistent with both any metadata definitions or suggestions received from the server-side application 36 and with any client-side platform-specific requirements and/or capabilities or lack thereof.

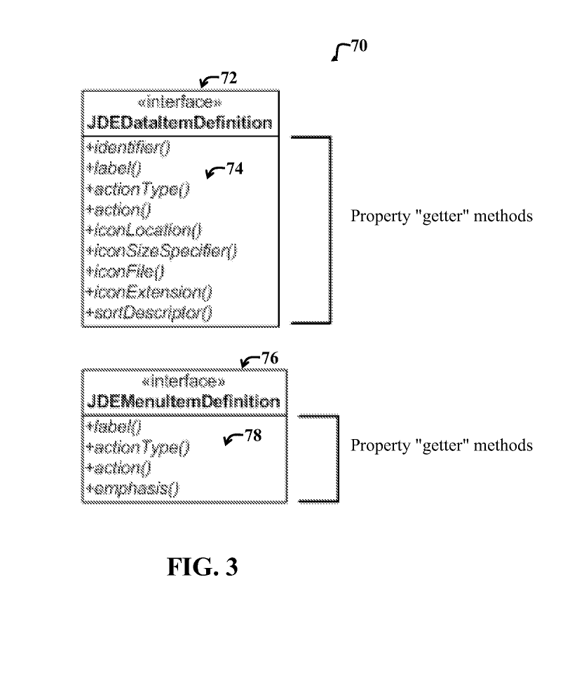

FIG. 3 is a diagram illustrating summaries of example object oriented computing objects (e.g., classes) 72, 76 representing JSON metadata definitions for an example data item UI element and an example menu item UI element.

Note that metadata retrieved from a server to characterize a client-side UI may contain several additional classes or other computing objects, which may communicate with the example JSON classes 72, 76 shown in FIG. 3. Furthermore, the definitions 72, 76 shown in FIG. 3 are merely examples. Those skilled in the art with access to the present teachings may readily determine and implement appropriate JSON definitions for implementing customizable dynamic client-side UI elements, which are customizable by client-side software to meet characteristics of a given platform.

For the purposes of the present discussion, a computing object may be any collection of data and/or functionality. Examples of computing objects include programming language data structures, such as classes, arrays, etc.

The first data item definition 72 and menu item definition 76 includes various property getter methods 74, 78, i.e., functions, for obtaining or getting information for rendering a dynamic client-side UI element. Client-side software may include built-in interfaces defining the structure.

The definitions 72, 76 may characterize interfaces or portions thereof for defining the structure of JSON configuration items received from the services delivering metadata UI element descriptions. Functions 74, 78 included in the definitions 72, 76 may be executed by client-side software after any requisite parsing or interpretation of the metadata definitions 72, 76.

Hence, the JSON definitions 72, 76, which may be included in one or more JSON files delivered from a server, represent computing objects characterizing interfaces that describe functions and/or appearances of the associated metadata-based UI elements.

The JSON metadata may further include computer code characterizing a functional intent of the associated metadata-based UI element. For the purposes of the present discussion, a description of a functional intent of a UI element may be any description characterizing what action(s) the UI element will be used for, i.e., the intended use of the UI element.

In general, JSON metadata descriptions used to generate dynamic UI elements discussed herein contain specifications for all needed data structures, e.g., classes, to render the native client-side dynamic UI elements. Objects are used for client-side rendering of UI elements, e.g., buttons, items in a table view or sidebar, and so on.

The process of marshaling JSON objects into client-specific UI elements may be similar for various platforms, including platforms running Android and handling HTML5.

An example pseudocode JSON specification for a UI element representing data items associated with the data item class definition 72 includes:

```
{“identifier”:“”, // Unique id of the item
“label”:“”, // Text to display for the item
“action”:“”, // Action that should be performed when the item is selected
“actionType”:“”, // Describes how the action should be executed
“iconLocation”:“”, // Specifies the path location where the icon file can be
“iconFile”:“”, // Specifies the file to retrieve to display as the item's icon
“iconSize”:“”, // Specifies an additional string to append to the file name
          // to Request a specific sized image. This may be based on
          //predetermined based on icon naming conventions
          //used in server-side software
“iconExtension”:“”, // The file extension of the icon
“sortValue”:“” // Name of the property to use to sort the items}
```

An example pseudocode specification for a UI element representing menu items associated with the menu item class definition 76 includes:

```
{“menuGroup”:“”, // Specifies a group of items as part of the same menu
“index”:“”, // Typically defines the display order
“label”:“”, // Text to display for the menu item
“action”:“”, // The action that should be performed when the menu is
      // selected
“actionType”:“”, // Describes how the action should be executed
“emphasis”:“” // Indicates that the client should highlight the menu item
          // in some way}
```

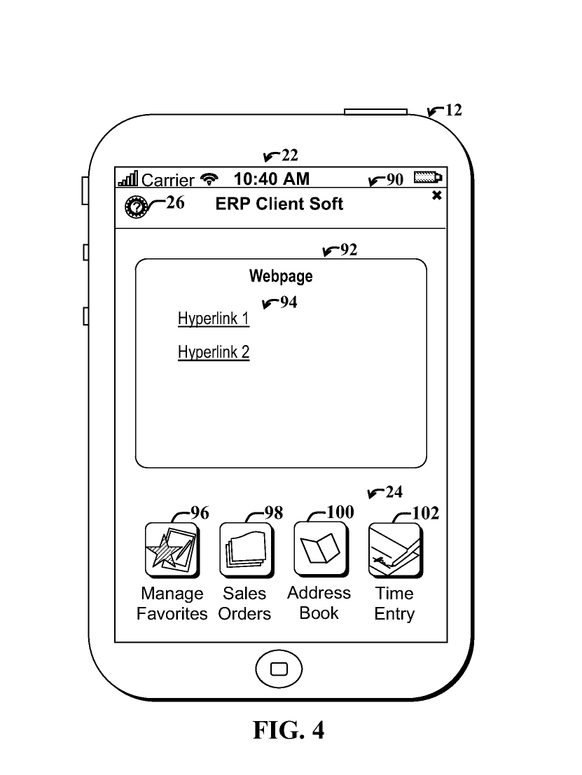

FIG. 4 is a diagram of an example client device 12 and accompanying user interface display screen 90 presented on the client display 22 and illustrating examples of dynamically generated native elements 24 based on metadata in combination with a webpage 92 and conventional HTML-based user interface elements 94.

For the purposes of the present discussion, a UI display screen may be any software-generated depiction presented on a display, such as the touch display 22. Examples of depictions include windows, dialog boxes, displayed tables, and any other graphical user interface features, such as user interface controls, presented to a user via software, such as a browser. User interface display screens may include various graphical depictions, including visualizations, such as graphs, charts, diagrams, tables, and so on.

The content for the webpage 92 may include HTML content that is retrieved from a server by an underlying web client or browser component of the hybrid client-side and server-side application used to display the UI screen 90.

The native elements 24 are metadata-based UI elements and include an example manage-favorites icon 96, a sales-order icon 98, an address-book icon 100, and a time-entry icon 102. Each of the icons 96-102 are associated with functions that are activated in response to user selection of the icons 96-102.

The called functions may be associated with web services or client-side functionality, which may be described via metadata used to generate the UI elements 24. Hence, UI elements (also called items), including action performed in response to user selection thereof, are delivered as JSON definition(s) from a server.

Note that a web client component of the underlying software used to generate the UI 90 may be adapted to consume the same JSON output (irrespective of platform), rather than receive HTML representation of the elements directly from a server. Associated server responses to client metadata requests may be client neutral, such that UI element rendering for client-side UIs is deferred client, as opposed to being delivered directly from a server via HTML JavaScript.

Note that conventionally, HTML elements, e.g., the elements 94 typically appear similar in the browsers running on different platforms. However the dynamic elements 24 represent implementations of centrally delivered (i.e., server delivered) UI element definitions of the UI that can manifest as native components on a particular platform, e.g., iOS, Android, Windows 8, and so on.

For example, in a hypothetical Windows 8 implementation, where the platform is capable of displaying live tiles, a Windows 8 client device may consume a metadata definition that results in display of the metadata-based UI element as a live tile. However, the same metadata definition used to generate a live tile in Windows 8 may be used to generate another type of icon or UI element in iOS that is consistent with iOS capabilities and features.

Hence, the same JSON metadata UI element definition on the back end (i.e., server side) describing the functional intent of the UI element may be yield different client-side UI element appearances that are tightly associated with the native appearance of UIs presented on the particular platform. In summary, a client device may consume/interpret metadata to facilitate implementing associated UI element appearances and actions based on the capabilities of the client device platform.

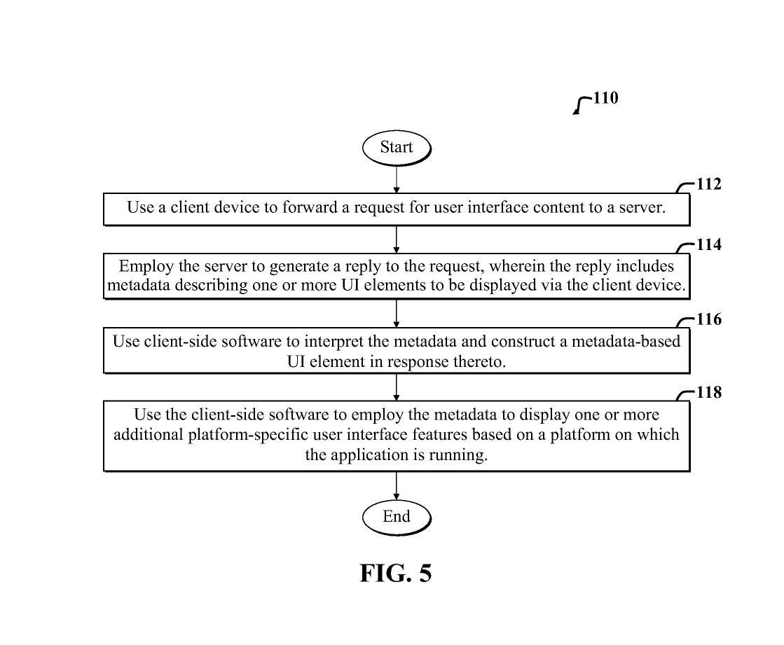

FIG. 5 is a flow diagram of an example method 110 adapted for use with the embodiments of FIGS. 1-4. The example method 110 is adapted to facilitate modifying a client user interface display screen via a server.

The example method 110 includes a first step 112, which involves using a client device to forward a request for user interface content to a server.

A second step 114 includes employing the server to generate a reply to the request, wherein the reply includes metadata describing one or more UI elements to be displayed via the client device.

A third step 116 includes utilizing client-side software to interpret the metadata and construct a metadata-based UI element in response thereto.

A fourth step 118 includes using client-side software to employ the metadata to display one or more platform-specific user interface features based on a platform on which the application is running.

For the purposes of the present discussion, a platform-specific UI feature may be any characteristic of a UI display screen, e.g., displayed elements and associated appearances and/or functions, layout of UI elements, UI styling, and so on, whose appearance and/or functionality differs depending upon a platform or operating system upon which the characteristic is displayed or used.

Note that various steps of the method 110 may be augmented, replaced, or rearranged without departing from the scope of the present teachings. For example, the method may further include defining one or more dynamic UI elements via JSON, wherein the definition includes a characterization of a UI element of a UI display screen, including a description of a behavior of the UI element, and a description of one or more actions that can be performed in response to user selection of the UI element, a characterization of a location of the UI element, and so on.

Hence, various embodiments discussed herein may be adapted to use a centrally delivered metadata definition of a client-side UI, where UI elements thereof are manifested as native components of a particular platform, e.g., iOS, Android, and so on. Use of a back-end metadata definition, as discussed herein, describing the functional intent of a UI and/or accompanying elements may result in different client-side UI appearances that are tightly associated with or reflective of the native appearance of the client device platform.

Although the description has been described with respect to particular embodiments thereof, these particular embodiments are merely illustrative, and not restrictive. For example, while embodiments are discussed herein with reference to use of JSON metadata of client-side UI elements, embodiments are not limited thereto. For example other mechanisms for representing and/or describing data structures, associative arrays, and other computing objects used to inform client-side software as to functional intent, layout preference, and so on, for construction of dynamic UI content in view of platform characteristics of the client, may be employed to implement embodiments without departing from the scope of the present teachings.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for generating a client user interface display, the method comprising:
receiving metadata from a server, wherein the metadata includes a description of one or more User Interface (UI) elements to be displayed on the client device; and
employing the metadata to display one or more platform-specific user interface features based on a platform on which the application is running.

2. The method of claim 1, further comprising:
displaying a User Interface (UI) element, by performing the following steps:
forwarding a request for user interface content to a server;
receiving a reply to the request, wherein the reply includes metadata describing one or more UI elements to be displayed via the client device; and
constructing a metadata-based UI element in response to at least a portion of the metadata.

3. The method of claim 2, wherein the metadata includes a definition of one or more UI elements.

4. The method of claim 2, wherein the definition includes a characterization of a UI element of a UI display screen, wherein the characterization includes a description of a behavior of the UI element, and a description of one or more actions that can be performed in response to user selection of the UI element.

5. The method of claim 4, wherein the characterization further includes a characterization of a location of the UI element.

6. The method of claim 2, further comprising:
generating one or more UI features from received metadata.

7. The method of claim 2, further comprising:
varying the metadata-based UI element depending upon a characteristic of the client device.

8. The method of claim 7, wherein the characteristic includes an operating system.

9. The method of claim 2, further comprising:
displaying the metadata-based UI element in a UI display screen in combination with one or more additional UI elements based on content, other than the metadata.

10. The method of claim 9, further comprising:
specifying the metadata, such that the metadata may be interpreted by different software of different client devices running different operating systems, thereby enabling different software running on different client devices to change one or more actions associated with the one or more metadata-based UI elements based on one or more characteristics of an accompanying operating system.

11. The method of claim 9, wherein the metadata is expressed via JavaScript Object Notation (JSON).

12. The method of claim 11, wherein the one or more JSON files include one or more computing objects characterizing or more functions and one or more appearances of the metadata-based UI element.

13. The method of claim 9, wherein the metadata includes computer code characterizing a function of the metadata-based UI element.

14. An apparatus comprising:
a digital processor coupled to a display and to a processor-readable storage device, wherein the processor-readable storage device includes one or more instructions executable by the digital processor to perform the following acts:
receiving metadata from a server, wherein the metadata includes a description of one or more User Interface (UI) elements to be displayed on the client device; and
employing the metadata to display one or more platform-specific user interface features based on a platform on which the application is running.

15. A processor-readable storage device including instructions executable by a digital processor, the processor-readable storage device including one or more instructions for:
receiving metadata from a server, wherein the metadata includes a description of one or more User Interface (UI) elements to be displayed on the client device; and
employing the metadata to display one or more platform-specific user interface features based on a platform on which the application is running.

16. A method for generating an interface specification, the method comprising:
sending a particular metadata description of one or more UI elements to a first client device running a first operating system; and
sending the particular metadata description to a second client device running a second operating system, wherein the second operating system is different from the first operating system, wherein the particular metadata description is used to construct different UI elements consistent with the first and second operating systems based on the metadata description.

17. The method of claim 16, wherein content other than the metadata includes HyperText Markup Language (HTML) content.

18. The method of claim 16, wherein at least one user interface element includes one or more dynamic native elements.

19. An apparatus comprising:
a digital processor coupled to a display and to a processor-readable storage device, wherein the processor-readable storage device includes one or more instructions executable by the digital processor to perform the following acts:
sending a particular metadata description of one or more UI elements to a first client device running a first operating system; and
sending the particular metadata description to a second client device running a second operating system, wherein the second operating system is different from the first operating system, wherein the particular metadata description is used to construct different UI elements consistent with the first and second operating systems based on the metadata description.

20. A processor-readable storage device including instructions executable by a digital processor, the processor-readable storage device including one or more instructions for:
sending a particular metadata description of one or more UI elements to a first client device running a first operating system; and
sending the particular metadata description to a second client device running a second operating system, wherein the second operating system is different from the first operating system, wherein the particular metadata description is used to construct different UI elements consistent with the first and second operating systems based on the metadata description.
